(19) United States
(12) Patent Application Publication
(10) Pub. No.: US 2014/0218292 A1
(43) Pub. Date: Aug. 7, 2014

(54) DATA SEARCHING METHOD AND SYSTEM

(71) Applicant: HON HAI PRECISION INDUSTRY CO., LTD., New Taipei (TW)

(72) Inventors: TAY-YANG LIN, New Taipei (TW); CHIN-FENG CHEN, New Taipei (TW); CHIA-JUNG LIU, New Taipei (TW); SHU-MING LIU, New Taipei (TW)

(73) Assignee: HON HAI PRECISION INDUSTRY CO., LTD., New Taipei (TW)

(21) Appl. No.: 14/160,564

(22) Filed: Jan. 22, 2014

(30) Foreign Application Priority Data
Feb. 1, 2013 (TW) 102104101

(51) Int. Cl. G06F 3/0488; G06F 3/0354

(52) U.S. Cl. CPC G06F 3/0488; G06F 3/03547
USPC 345/158

(57) ABSTRACT

An electronic device includes a touch-sensitive screen, a cursor locating module, a touch detecting module, and a user interface (UI) generating module. The cursor locating module locates a cursor in a graphical user interface (GUI) displayed on the touch-sensitive screen. The touch detecting module detects whether a point of the touch-sensitive screen corresponding to the cursor is continuously pressed for a preset time duration. When the point is continuously pressed for the preset time duration, the UI generating module generates a search UI and displays the search UI adjacent to the cursor in the GUI. A method for searching data in a touch-sensitive device is also provided.

### REFERENCE TO RELATED APPLICATIONS

This application claims all benefits accruing under 35 U.S.C. §119 from Taiwan Patent Application No. 102104101, filed on Feb. 1, 2013 in the Taiwan Intellectual Property Office. The contents of the Taiwan Application are hereby incorporated by reference.

### BACKGROUND

1. Technical Field

The disclosure generally relates to touch-sensitive devices, and particularly relates to methods and systems for searching data in a touch-sensitive device.

2. Description of Related Art

Touch-sensitive devices enable a user to provide input to a computing device by interacting with a touch-sensitive screen or other surface of the device. However, to search data in the touch-sensitive device, the user has to perform multiple actions on the touch-sensitive device, such as finding a corresponding search box and inputting a keyword in the search box. Thus, the search method does not take advantage of the touch-sensitive functionality of the touch-sensitive device.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of an electronic device suitable for implementing a data searching system.

FIG. 2 is a block diagram of one embodiment of the data searching system.

FIG. 3 is a schematic view of an embodiment of a cursor located in a desktop user interface (UI) displayed on a touch-sensitive screen.

FIG. 4 is a schematic view of an embodiment of a point of the touch-sensitive screen corresponding to the cursor being pressed by a finger of a user.

FIG. 5 is a schematic view of an embodiment of a search UI displayed adjacent to the cursor.

FIG. 6 is a schematic view of an embodiment of displaying matched files and folders in the search UI.

FIG. 7 is a flowchart of one embodiment of a data searching method implemented by the electronic device of FIG. 1.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

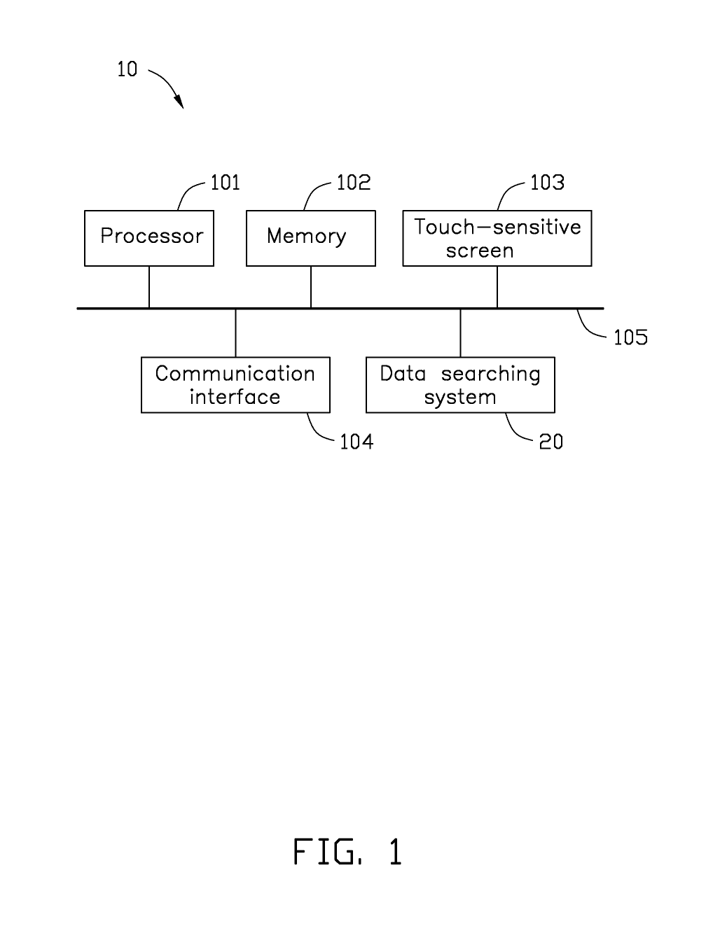

FIG. 1 is a block diagram of an exemplary embodiment of an electronic device 10 suitable for implementing a data searching system 20. The illustrated embodiment of the electronic device 10 includes, without limitation: at least one processor 101, a suitable amount of memory 102, a touch-sensitive screen 103, and a communication interface 104. In other embodiments, the electronic device 10 may include additional elements, components, and modules, and be functionally configured to support various features that are unrelated to the subject matter described here. In practice, the elements of the electronic device 10 may be coupled together via a bus or any suitable interconnection architecture 105.

The processor 101 may be implemented or performed by a general purpose processor, a content addressable memory, a digital signal processor, an application specific integrated circuit, a field programmable gate array, any suitable programmable logic device, discrete gate or transistor logic, discrete hardware components, or any combination thereof designed to perform the functions described here.

The memory 102 may be realized as RAM memory, flash memory, EPROM memory, EEPROM memory, registers, a hard disk, a removable disk, a CD-ROM, or any other form of storage medium known in the art. The memory 102 is coupled to the processor 101, such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The touch-sensitive screen 103 may detect and recognize touch gestures input by a user of the electronic device 10. The touch-sensitive screen 103 is suitably configured to enable the electronic device 10 to render and display various screens, graphical user interfaces (GUIs), GUI control elements, drop-down menus, auto-fill fields, text entry fields, message fields, or the like. The touch-sensitive screen 103 may also be utilized for the display of other information during the operation of the electronic device 10, as is well understood.

The communication interface 105 may provide connectivity channels for receiving and transmitting information and/or for connecting to other electronic devices. The communication interface 105 may be, but is not limited to, a network interface card (NIC) or a network controller. The communication interface 105 may include a local area network (LAN) interface for connecting to a wired Ethernet-based network and/or a wireless LAN, such as an IEEE 802.11x wireless network.

The communication interface 105 also may include a wide area network (WAN) interface that permits connection to the Internet via a cellular data network, such as the Enhanced Data rates for GMS Evolution (EDGE) network or a 3G or 4G network. Further, the communication interface 105 may include a personal area network (PAN) interface for connecting to a BLUETOOTH® network, an IEE 802.15.4 (Zig-Bee) network, or an ultra-wideband network (UWB). The communication interface 105 may include any number and combination of network interfaces. The communication interface 105 can employ one or more protocols, such as the High-Speed Downlink Packet Access (HSDPA) protocol, for rapidly downloading data over an Internet Protocol (IP) network.

The data searching system 20 may be implemented using software, firmware, or other computer programming technologies.

The electronic device 10 may be realized in any common form factor including, without limitation: a desktop computer, a mobile computer (e.g., a tablet computer, a laptop computer, or a netbook computer), a smartphone, a video game device, a digital media player, or the like.

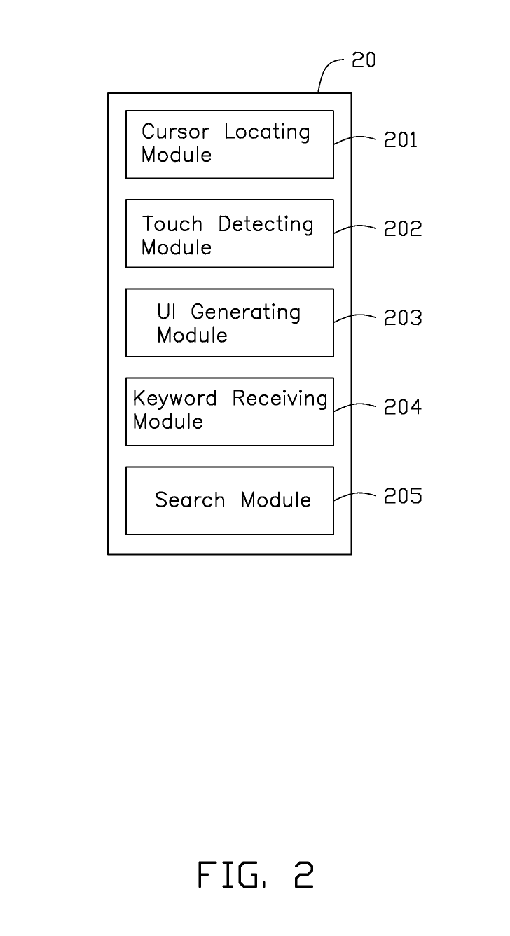

FIG. 2 shows a block diagram of an embodiment of the data searching system 20 implemented in the electronic device 10. The data searching system 20 includes a cursor locating module 201, a touch detecting module 202, a UI generating module 203, a keyword receiving module 204, and a search module 205.

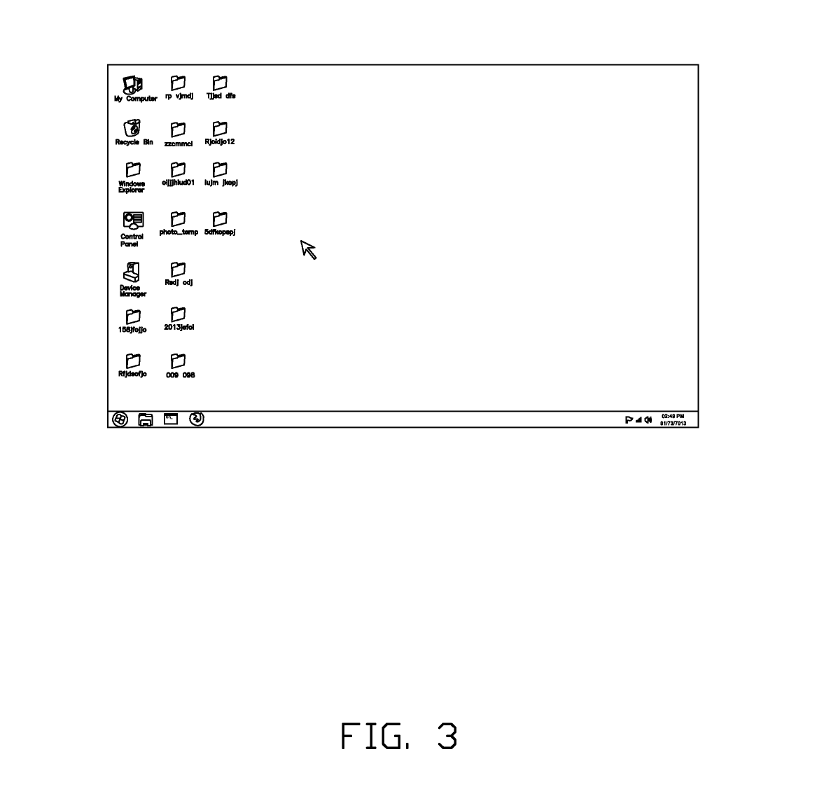

The cursor locating module 201 locates a cursor in a GUI displayed on the touch-sensitive screen 103. The cursor indicates a point on the touch-sensitive screen 103 that will respond to input from a text input or pointing device. The cursor may be a text cursor or a mouse cursor. For example, FIG. 3 shows a mouse cursor on a desktop of the touch-sensitive screen 103.

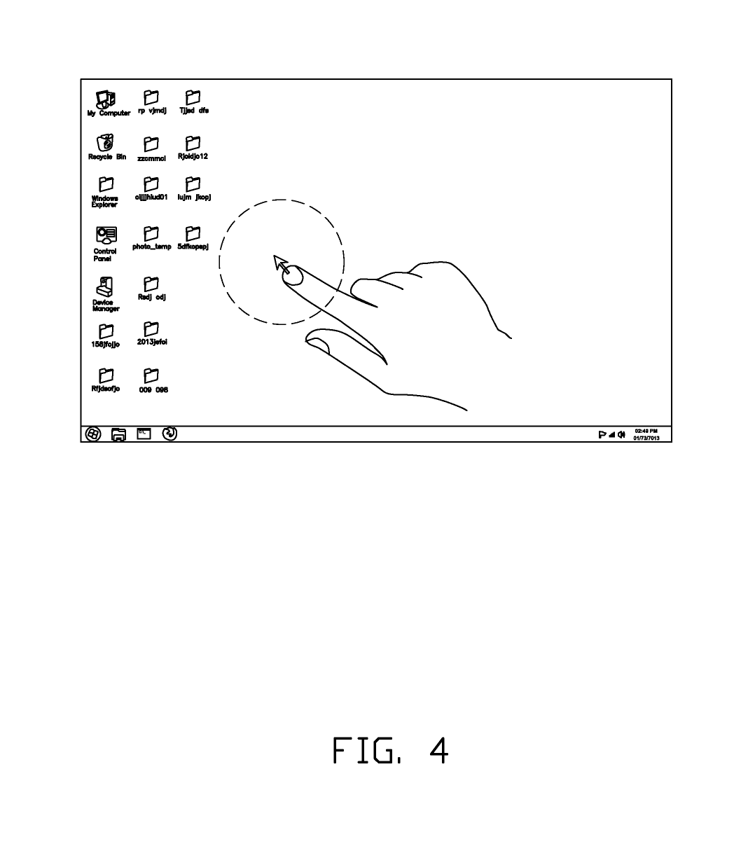

The touch detecting module 202 detects whether a point of the touch-sensitive screen 103 corresponding to the cursor is continuously pressed for a preset time duration such as three seconds. For example, FIG. 4 shows that the point is pressed by a finger of the user. The touch detecting module 202 detects whether the point is pressed for the preset time duration.

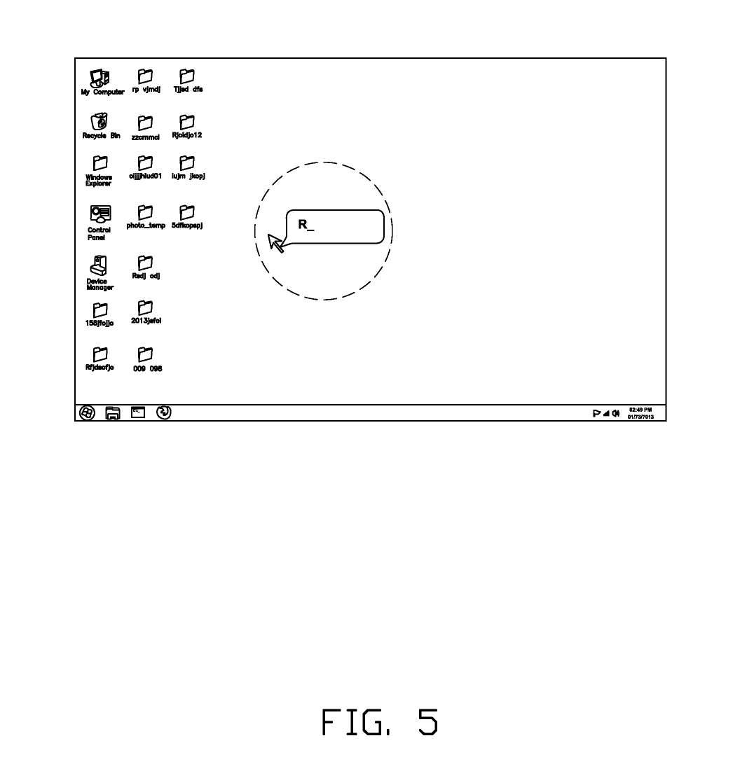

When the touch detecting module 202 detects that the point is continuously pressed for the preset time duration, the UI generating module 203 generates a search UI and displays the search UI adjacent to the cursor in the GUI displayed on the touch-sensitive screen 103. For example, FIG. 5 shows the search UI displayed adjacent to the mouse cursor.

The keyword receiving module 204 may receive a keyword input in the search UI.

The search module 205 searches data displayed in the GUI where the cursor is located according to the keyword received by the keyword receiving module 204. When one or more data items match the keyword, the search module 205 may highlight the one or more matched data items. In other embodiments, the search module 205 may display the one or more matched data items in the search UI.

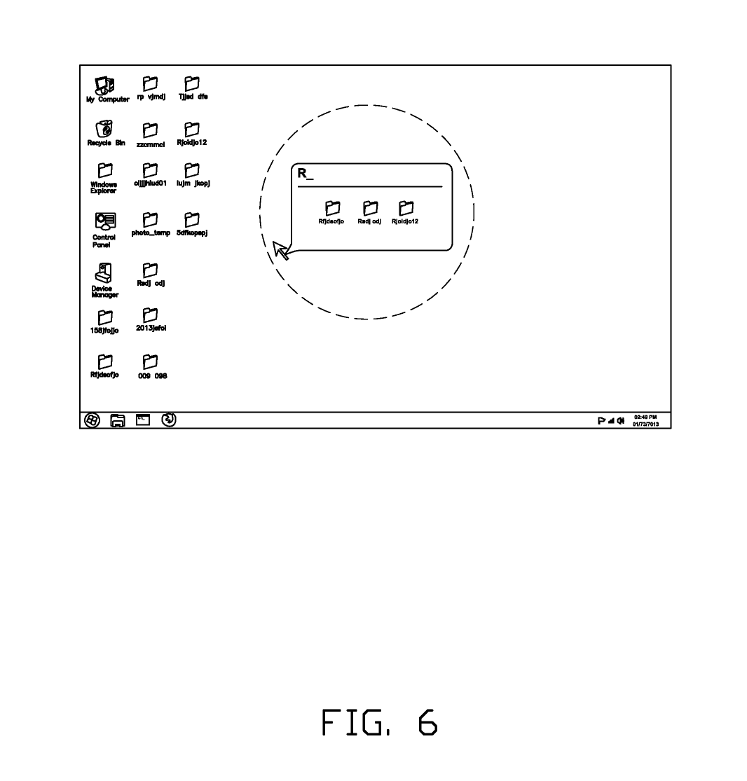

FIGS. 3-5 show that when the GUI where the cursor is located is a desktop UI of the electronic device 10, the search module 205 searches the files and folders located in the desktop UI according to the keyword. When a name of a file or folder starts with the keyword, the search module 205 determines that the file or folder matches the keyword and highlights the matched file or folder. In other embodiments, as shown in FIG. 6, the search module 205 displays the matched files or folders in the search UI.

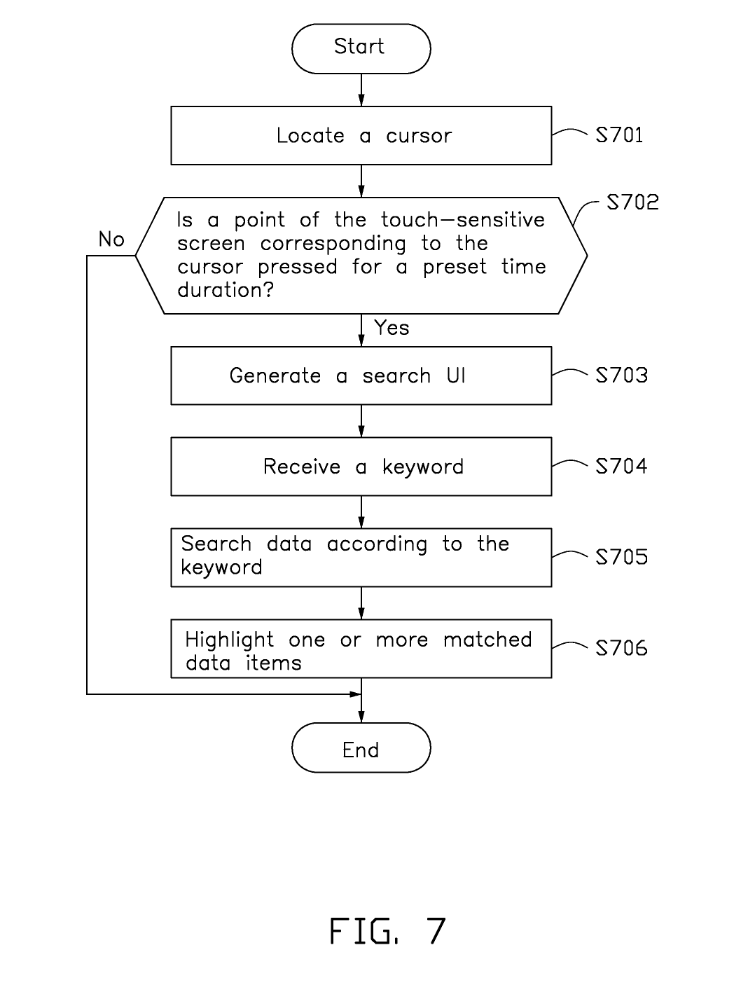

FIG. 7 shows a flowchart of one embodiment of a data searching method implemented by the electronic device 10. The method includes the following steps.

In step S701, the cursor locating module 201 locates a cursor in a GUI displayed on the touch-sensitive screen 103.

In step S702, the touch detecting module 202 detects whether a point of the touch-sensitive screen 103 corresponding to the cursor is continuously pressed for a preset time duration such as three seconds. If the point is continuously pressed for the preset time duration, the procedure proceeds to step S703. Otherwise, the procedure ends.

In step S703, the UI generating module 203 generates a search UI and displays the search UI adjacent to the cursor in the GUI displayed on the touch-sensitive screen 103.

In step S704, the keyword receiving module 204 receives a keyword input in the search UI.

In step S705, the search module 205 searches data displayed in the GUI where the cursor is located according to the keyword received by the keyword receiving module 204.

In step S706, when one or more data items match the keyword, the search module 205 highlights the one or more matched data items. In other embodiments, the search module 205 displays the one or more matched data items in the search UI.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An electronic device, comprising:
a touch-sensitive screen;
a memory;
at least one processor coupled to the memory;
one or more programs being stored in the memory and executable by the at least one processor, the one or more programs comprising:
a cursor locating module configured for locating a cursor in a graphical user interface (GUI) displayed on the touch-sensitive screen;
a touch detecting module configured for detecting whether a point of the touch-sensitive screen corresponding to the cursor is continuously pressed for a preset time; and
a user interface (UI) generating module configured for generating a search UI and displaying the search UI adjacent to the cursor in the GUI when the touch detecting module detects that the point of the touch-sensitive screen corresponding to the cursor is continuously pressed for the preset time duration.

2. The electronic device of claim 1, further comprising a keyword receiving module configured for receiving a keyword input by a user via the search UI.

3. The electronic device of claim 2, further comprising a search module configured for searching data displayed in the GUI where the cursor is located according to the keyword.

4. The electronic device of claim 3, wherein the search module is further configured for highlighting one or more data items which match the keyword.

5. The electronic device of claim 3, wherein when the GUI where the cursor is located is a desktop UI, the search module is configured for searching files and folders located in the desktop UI according to the keyword.

6. The electronic device of claim 5, wherein the search module is further configured for highlighting one or more files or folders which match the keyword.

7. The electronic device of claim 6, wherein the search module is configured for highlighting the file or folder when a name of the file or folder starts with the keyword.

8. The electronic device of claim 3, wherein the search module is further configured for displaying one or more data items which match the keyword in the search UI.

9. A method for searching data in an electronic device, the method comprising:
locating a cursor in a graphical user interface (GUI) displayed on a touch-sensitive screen of the electronic device;
detecting whether a point of the touch-sensitive screen corresponding to the cursor is continuously pressed for a preset time duration; and
generating a search user interface (UI) and displaying the search UI adjacent to the cursor in the GUI when the point of the touch-sensitive screen corresponding to the cursor is continuously pressed for the preset time duration.

10. The method of claim 9, further comprising receiving a keyword input in the search UI.

11. The method of claim 10, further comprising searching data displayed in the GUI where the cursor is located according to the keyword.

12. The method of claim 11, further comprising highlighting one or more data items which match the keyword.

13. The method of claim 11, further comprising, when the GUI where the cursor is located is a desktop UI, searching files and folders located in the desktop UI according to the keyword.

14. The method of claim 13, further comprising highlighting one or more files or folders which match the keyword.

15. The method of claim 14, wherein the highlighting the one or more files or folders further comprises, when a name of a file or folder starts with the keyword, highlighting the file or folder.

16. The method of claim 11, further comprising displaying one or more data items which match the keyword in the search UI.
